(19) United States
(12) Patent Application Publication
(10) Pub. No.: US 2014/0160735 A1
(43) Pub. Date: Jun. 12, 2014

(54) LIGHT EMITTING DIODE ARRAY FOR ENHANCING APPEARANCE OF FISH

(71) Applicant: CENTRAL GARDEN & PET COMPANY, Walnut Creek, CA (US)

(72) Inventors: Glen S. AXELROD, Colts Neck, NJ (US); Ajay GAJRIA, Pune (IN)

(21) Appl. No.: 13/893,469

(22) Filed: May 14, 2013

Related U.S. Application Data
(60) Provisional application No. 61/646,851, filed on May 14, 2012.

(51) Int. Cl. A01K 63/06

(52) U.S. Cl. CPC A01K 63/06
USPC 362/101; 362/231

(57) ABSTRACT

A lighting system for a habitat including one or more light emitting diode capsules, wherein the capsules are configured to emit red light in the wavelength range of 615 nm to 630 nm, green light in the wavelength range of 510 nm to 530 nm, and blue light in the wavelength range of 455 nm to 475 nm. The system may also include a carrier, to which the light emitting diode capsules are mounted including circuitry for controlling the light emitting diodes.

### CROSS-REFERENCE TO RELATED APPLICATIONS

The present application claims the benefit of the filing date of U.S. Provisional Application Ser. No. 61/646,851 filed on May 14, 2012, the teachings of which are incorporated herein by reference.

### FIELD

The present disclosure relates to the use of a light emitting diode array for enhancing the appearance of fish.

### BACKGROUND

Aquarium lighting is generally considered an important factor in developing an aesthetically pleasing aquatic habitat. In addition, aquarium lighting may serve the more functional purpose of providing a healthy environment, supporting the growth of creatures or plants inside of the habitat. Incandescent, fluorescent, metal halide and other lighting sources have been utilized for aquarium lighting. These lighting sources may exhibit various black body temperatures and/or simulate day-light or moon-light. However, these lighting systems may influence the perceived color of fishes in the tank to a relatively small degree. These light sources may also be relatively inefficient in terms of energy consumption. Furthermore, as some of these light sources age, the spectrum of light emitted may shift.

More recently, LED's, or light emitting diodes, have been incorporated into aquarium lighting as the cost of producing LED's has decreased. LED's are generally considered relatively more efficient in terms of energy consumption. Color LED lighting has been used to enhance the color of fish. However, color LED lighting may also affect the appearance of nearly everything else in the tank, not just the fishes, creating an undesirable result. For example, it may be more desirable for gravel to be brown or gray and plants to be green, but color LEDs may alter the perceived hues of these materials. Accordingly, there still remains room for improvement in aquatic lighting systems, which not only enhance the color of fishes but maintain the more natural hues of other objects within the aquarium.

### SUMMARY

In one aspect the present disclosure relates to a lighting system for a habitat. The system may include one or more light emitting diode capsules, wherein the capsules are configured to emit red light in the wavelength range of 615 nm to 630 nm, green light in the wavelength range of 510 nm to 530 nm, and blue light in the wavelength range of 455 nm to 475 nm. The system may also include a carrier, to which the light emitting diode capsules are mounted including circuitry for controlling the light emitting diodes.

In another aspect, the present disclosure relates to a method of lighting a habitat. The method may include positioning a lighting system on a habitat and emitting light into the habitat from the lighting system.

### BRIEF DESCRIPTION OF THE DRAWINGS

The above mentioned and other features of this disclosure, and the manner of attaining them, may become more apparent and better understood by reference to the following description of the embodiments described herein taken in conjunction with the accompanying drawings, wherein:

FIG. 1 illustrates an example of an aquarium and a lighting system;

FIGS. 2a and 2b illustrate a top view and side view, respectively, of an example of a lighting system including a number of LED arrays or capsules;

FIG. 3 illustrates an example of circuitry for a lighting system; and

FIG. 4 illustrates another example of circuitry for a lighting system.

### DETAILED DESCRIPTION

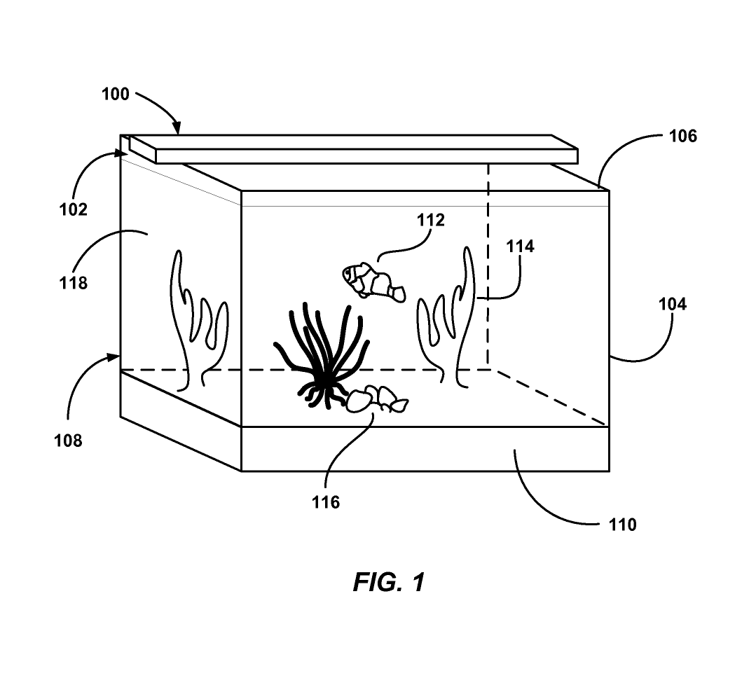

The present disclosure relates to the use of a lighting system including light emitting diode arrays for enhancing the appearance of fish color in an aquarium, observation tank or other habitat as well as enhancing the color of other objects in the habitat. As illustrated in FIG. 1, the lighting system 100 may be positioned on the upper portion 102 of an aquarium tank 104, such as on the rim 106 of the aquarium tank 104. The lighting system may be placed on the rim or mounted to the rim using a friction fit or mechanical fasteners. In other embodiments, the lighting system may be positioned at or near the bottom 108 of the tank 104, such as underneath 110 the tank 104. The lighting system 100 may enhance the color of ornamental fish 112 in water 118 and provide a combination of green, red and blue lighting of selected wavelengths and luminous flux. A power supply may be provided to the lighting system in the form of a plug connected to a wall outlet, solar generated power, or battery power.

The lighting system may enhance the color of many ornamental fishes 112 such as gold fish, koi, swordtail, etc., wherein the color of the fishes may appear stronger and brighter than with other lighting sources. The color of other items, such as coral or plants 114, rocks 116, etc. in the tank may also be positively affected by the lighting system, creating a stronger appearance in the color of these additional objects. Thus, as compared to traditional lighting sources, the lighting system herein may make the entire tank look relatively brighter and provide more visual enjoyment as well as a healthy habitat for the specimens therein.

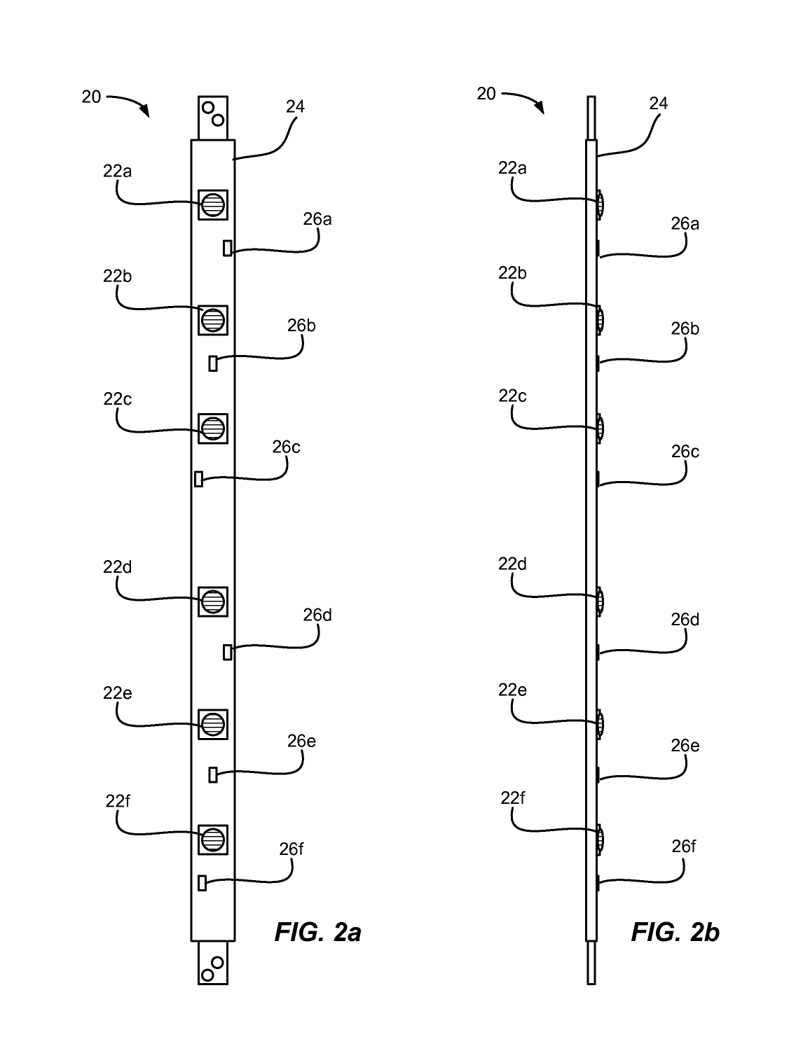

As alluded to above, the lighting system utilizes one or more light emitting diodes (LED's) configured to emit light of red, green and blue wavelengths, generating white light having red hues, purple hues or both red and purple hues in the air. FIGS. 2a and 2b illustrate an example of a lighting system 20 including a plurality of arrays or capsules 22a, 22b, 22c, etc. (herein after referred to as 22), wherein each capsule 22 includes red, green and blue diodes mounted to a printed circuit board 24 or other carrier. Also provided on the printed circuit board are electronic circuits and other components, such as resistors 26a, 26b, 26c (etc.), discussed further herein, for controlling the blending and diffusion of the different colors of light emitted by the LED's. While the lighting system 20 of FIG. 2 is illustrated as including six (6) LED capsules 22 arranged in a row, one (1) to 100 LED capsules, including all values and ranges therein, may be provided in any number of patterns depending on the habitat geometry that the lighting system may be utilized for. For example, multiple rows, circles, octagons, or other geometric configurations may be provided for with the LED capsules.

Each light emitting diode capsule may include, consist essentially of, or consist of one or more diodes or chips that emit light in the following wavelength ranges: red at 615 nm to 630 nm, green at 510 nm to 530 nm, and blue at 455 nm to 475 nm, including all values and ranges within the recited ranges. Preferably, the light emitting diode capsules are configured to emit light in the following wavelengths: red at 620 nm to 625 nm, green at 520 nm to 525 nm, and blue at 465 nm to 470 nm. Reference to red, green and blue diodes may be understood as reference to the color light, i.e., wavelength of light, the diodes emit, not necessarily the actual color of the diodes themselves. Other color diodes may be utilized in addition to those wavelength ranges specified above, such as diodes emitting at one or more wavelengths in the visible range of approximately 400 nm to 760 nm, including all values and ranges therein, such as 400 nm to 455 nm, 475 nm to 510 nm, 530 nm to 570 nm, 570 nm to 590 nm, 590 nm to 615 nm, or 630 nm to 760 nm, diodes emitting at one or more wavelengths in the UV range having wavelengths in the range of 200 nm to 400 nm, or diodes emitting at one or more wavelengths in the IR range having wavelengths in the range of 760 nm to 1000 nm, as well as combinations thereof.

Furthermore, the luminous flux of each color, i.e., red, green and blue, may be selectively controlled, such that red exhibits a luminous flux of 32% to 41%, green exhibits a luminous flux of 47% to 54%, and blue exhibits a luminous flux of 12% to 15%, including all values and ranges within the ranges (i.e., red, green and blue luminous flux ranges). Luminous flux may be understood as a measurement of the perceived power of light, which is adjusted to reflect the varying sensitivity of the human eye to different wavelengths of light. The luminous flux may be adjusted as the arrangement of the diodes is altered.

To obtain the desired lighting characteristics including luminous flux, adjustments may be made to the power provided to the lighting chips in each LED array or capsule, the size of the lighting chips may be altered, or the number of each color of lighting chips in each LED capsule may be varied. Preferably, to obtain the desired white light with slight red and purple hues in air, the percentage of red light emitted relative to the other colors, i.e., green and blue, may be increased by utilizing more than one red LED chip in each capsule, increasing the size of the red LED, or supplying more power to the red LED chips.

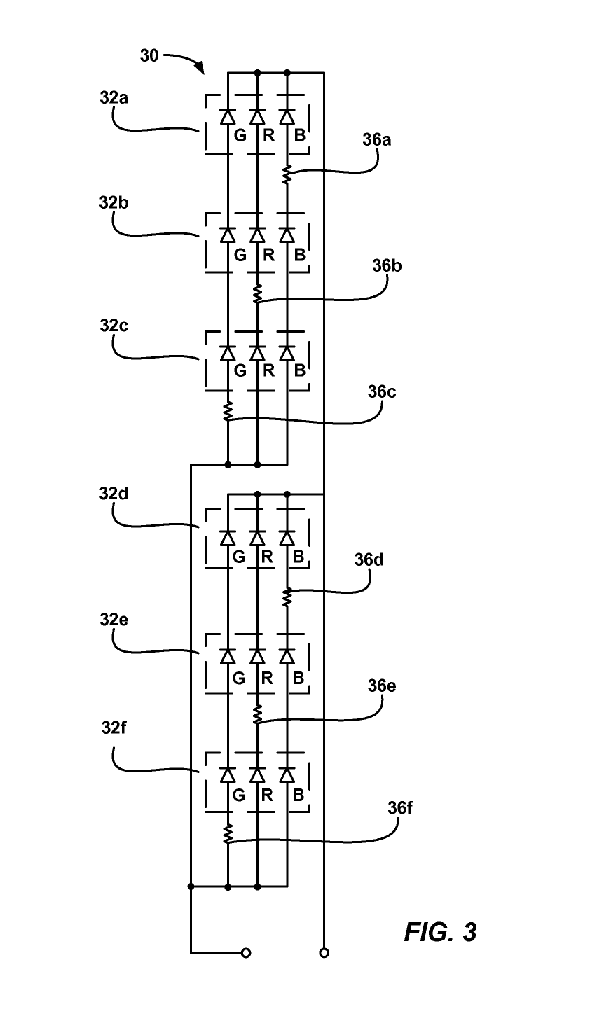

FIG. 3 illustrates circuitry 30 of a lighting system (such as the system illustrated in FIG. 2) and a first arrangement of diode capsules 32a, 32b, 32c, etc. (herein after referred to as 32), wherein each capsule 32 includes three light emitting diodes or chips of red (R), green (G) and blue (B) color. As illustrated, the ratio of red, green and blue diodes in a single capsule is 1:1:1. Power to the diodes may be regulated utilizing resistors 36a, 36b, 36c, etc. (herein after referred to as 36) associated with the diodes, which exhibit different resistances. In this figure, the resistors associated with the blue diodes (36a, 36d) and associated with the green diodes (36c, 36f), may exhibit a first resistance R₁, e.g., 150 Ohms. The resistors associated the red diodes (36b, 36e) may exhibit a second resistance R₂, e.g., 220 Ohms. The second resistance R₂ may be greater than the first resistance R₁, wherein R₁ <R₂. In some embodiments, the second resistance may be up to five times greater than the first resistance wherein R₁*x=R₂, wherein x may be in the range of 1.1 to 5.0, including all values and increments therein, such as 1.47, 1.50, 1.55, etc. The luminous flux of each color in the arrangement of FIG. 3 may be configured such that the resulting red light exhibits a luminous flux of 32.1%, the green light exhibits a luminous flux of 53.7% and the blue light exhibits a luminous flux of 14.2%.

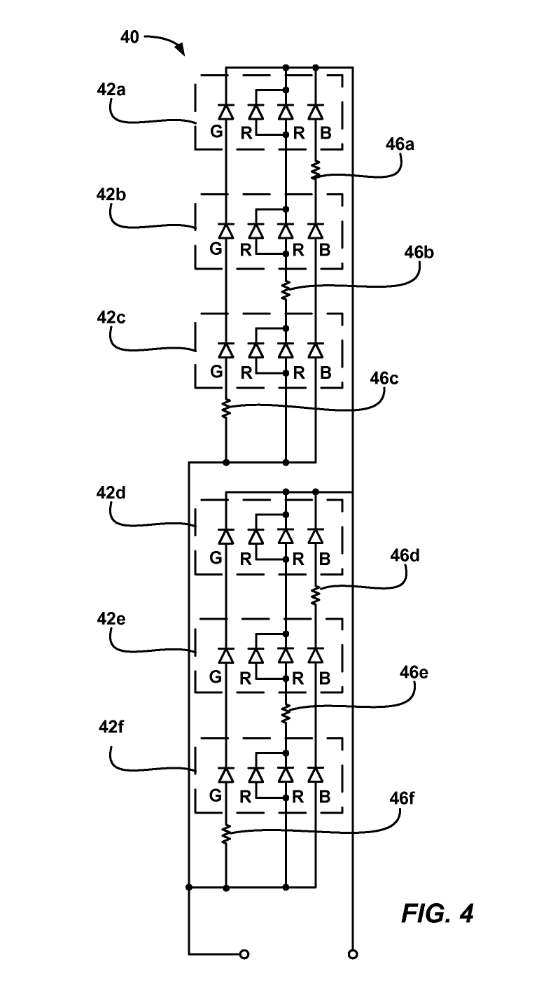

FIG. 4 illustrates circuitry 40 of a lighting system (such as the system illustrated in FIG. 2) and another arrangement of diode capsules 42a, 42b, 42c, etc. (herein after referred to as 42), wherein each capsule 42 includes four light emitting diodes or chips of red (R), green (G) and blue (B) color. As illustrated, the ratio of red, green and blue diodes in a single capsule is 2:1:1, i.e., two red diodes may be present for each green diode and blue diode. Power to the diodes may be regulated utilizing resistors 46a, 46b, 46c, etc. (herein after referred to as 46) associated with the diodes, which exhibit different resistances. In this figure, the resistors associated with the blue diodes (46a, 46d), green diodes (46c, 46f), and red diodes (46b, 46e) may exhibit generally the same resistance, e.g., 150 Ohms, within plus or minus 2% of the average resistance value. The luminous flux of each color in the arrangement of FIG. 4 may be configured such that the red diodes exhibit a luminous flux of 40.0%, the green diodes exhibit a luminous flux of 57.2% and the blue diodes exhibit a luminous flux of 12.8%.

When used in combination with an aquatic habitat, the arrangement of the light emitting diodes and the luminous flux of red lighting may be adjusted depending on the depth of the aquatic system or the depth of the desired penetration of the light into water. With increasing depth, a higher red luminous flux may be selected. For example, for color enhancement in water deeper than one (1) meter, the arrangement of FIG. 3 may be utilized, where one red LED may be provided in each array or capsule having a larger size than the other chips and greater power may be supplied to the red LED than to the other LED's. For color enhancement in water one (1) meter or less in depth, the arrangement of FIG. 4 may be utilized, wherein two red LED's of generally the same size may be provided in each array or capsule and generally the same power may be supplied to the red, green and blue LED's.

In addition, other arrangements, sizes or ratios of red, green and blue diodes and different resistance values may be selected to create a desired color enhancement. In some embodiments, the values of resistance may be altered to tune the colors to an individual habitat. For example, variable resistors may be employed to fine tune the output of each LED. In other embodiments, once the lighting systems have been assembled, the values of resistance may not be changeable.

Associated drivers, cooling systems and power supplies may also be provided on or in conjunction with the printed circuit board to control and regulate the lighting systems. In addition, sensors may be provided that detect lighting conditions surrounding or within the aquarium or habitat. A processor may then be used to adjust the lighting provided within the habitat based on the detected lighting conditions. For example, the power supplied to the red, green and blue LED's may be tuned to adjust the lighting based on the sensed conditions.

As noted above, the lighting system herein may emit light that appears to be “white” with slight purple and red tones in air having the following uniquely selected wavelength ranges: red at 615 nm to 630 nm, green at 510 nm to 530 nm, and blue at 455 nm to 475 nm, wherein red exhibits a luminous flux of 32% to 41%, green exhibits a luminous flux of 47% to 54%, and blue exhibits a luminous flux of 12% to 15%, including all values and ranges therein. These wavelengths and luminous flux values have been selected such that the emitted light does not substantially change the color of the water, keeping the water's natural color and meeting the expectation of the fish keeper or aquarist, all the while enhancing the color of the fishes. The use of the lighting system is not limited to enhancing aquarium lighting and other habitats or observation tanks, but may also be used for the purposes of enhancing room lighting as well, such that the color of various objects in a room appears stronger and brighter. Accordingly, also provided herein are methods for lighting a habitat, including dry habitats or marine habitats using the above described lighting systems for enhancing the color of the fishes therein. Light may be emitted from the lighting system into the habitat for illuminating the creatures or other items (plant, coral, rocks, etc.) within the habitat.

The foregoing description of several methods and embodiments has been presented for purposes of illustration. It is not intended to be exhaustive or to limit the claims to the precise steps and/or forms disclosed, and obviously many modifications and variations are possible in light of the above teaching. It is intended that the scope of the invention be defined by the claims appended hereto.

What is claimed is:

1. A lighting system for a habitat, comprising:
one or more light emitting diode capsules, wherein said capsules are configured to emit red light in the wavelength range of 615 nm to 630 nm, green light in the wavelength range of 510 nm to 530 nm, and blue light in the wavelength range of 455 nm to 475 nm; and
a carrier to which said light emitting diode capsules are mounted.

2. The system of claim 1, wherein the luminous flux of said red light is in the range of 32% to 41%, the luminous flux of said green light is in the range of 47% to 54%, and the luminous flux of said blue light is in the range of 12% to 15%.

3. The system of claim 1, wherein said capsules are configured to emit said red light in the wavelength range of 620 nm to 625 nm, said green light in the wavelength range of 520 nm to 525 nm, and said blue light in the wavelength range of 465 nm to 470 nm.

4. The system of claim 1, wherein each capsule includes three light emitting diodes including one red diode that emits said red light, one green diode that emits said green light and one blue diode that emits said blue light.

5. The system of claim 4, wherein the luminous flux of said red light is 32.1%, the luminous flux of said green light is 53.7% and the luminous flux of said blue light is 14.2%.

6. The system of claim 4, further comprising one or more first resistors associated with said green diode and said blue diode, wherein said first resistors exhibit a first resistance R₁ and one or more second resistors associated with said red diode, wherein said second resistors exhibit a second resistance R₂, wherein said second resistance is greater than said first resistance, wherein R₁≦R₂.

7. The system of claim 1, wherein each capsule includes four light emitting diodes including two red diodes that emits said red light in the wavelength range of 615 nm to 630 nm, one green diode that emits said green light in the wavelength range of 510 nm to 530 nm and one blue diode that emits said blue light in the wavelength range of 455 nm to 475 nm.

8. The system of claim 7, wherein the luminous flux of said red light is 40.0%, the luminous flux of said green light is 57.2% and the luminous flux of said blue light is 12.8%.

9. The system of claim 1, wherein said habitat is an aquarium including water.

10. The system of claim 4, wherein said habitat is an aquarium including water greater than 1 meter deep.

11. The system of claim 7, wherein said habitat is an aquarium including water 1 meter deep or less.

12. The system of claim 1, wherein said habitat includes a rim and said lighting system is positioned on said rim.

13. The system of claim 1, wherein said lighting system is disposed underneath said habitat.

14. A method of lighting a habitat, comprising:
positioning a lighting system on a habitat, wherein said lighting system comprising one or more light emitting diode capsules, wherein said capsules are configured to emit red light in the wavelength range of 615 nm to 630 nm, green light in the wavelength range of 510 nm to 530 nm, and blue light in the wavelength range of 455 nm to 475 nm, and a carrier to which said light emitting diode capsules are mounted; and
emitting light into said habitat from said lighting system.
